(19) United States
(12) Patent Application Publication
(10) Pub. No.: US 2018/0367262 A1
(43) Pub. Date: Dec. 20, 2018

(54) TECHNIQUES OF TRANSMITTING HARQ-ACK FEEDBACK BY USER EQUIPMENT

(71) Applicant: Mediatek Inc., Hsin-Chu (TW)

(72) Inventors: Chien Hwa Hwang, Hsinchu (TW); Pei-Kai Liao, Hsinchu (TW); Yen Shuo Chang, Hsinchu (TW); MingChe Lu, Hsinchu (TW)

(21) Appl. No.: 16/006,060

(22) Filed: Jun. 12, 2018

Related U.S. Application Data
(60) Provisional application No. 62/519,211, filed on Jun. 14, 2017.

(51) Int. Cl. H04L 1/18; H04W 72/04

(52) U.S. Cl. CPC H04L 1/1861; H04W 72/0446

(57) ABSTRACT

In an aspect of the disclosure, a method, a computer-readable medium, and an apparatus are provided. The apparatus may be a UE. The UE receives, on a down-link, an indication indicating a first number of predetermined time units for delaying sending an acknowledgment message after receiving data in a slot. The UE obtains one or more conditions based on the first number, the one or more conditions affecting time required for processing the data received in the slot and affecting a duration of a predetermined time unit. The UE determines whether at least one of the one or more conditions is met. The UE further sends, on an uplink, the acknowledgment message according to the first number predetermined time units after receiving the data in the slot when at least one of the one or more conditions is met.

### CROSS-REFERENCE TO RELATED APPLICATION(S)

This application claims the benefit of U.S. Provisional Application Ser. No. 62/519,211, entitled “METHOD FOR TRANSMITTING HARQ-ACK FEEDBACK BY A USER EQUIPMENT” and filed on Jun. 14, 2017, which is expressly incorporated by reference herein in their entirety.

### BACKGROUND

### Field

The present disclosure relates generally to communication systems, and more particularly, to a UE that determines a delay for transmitting a hybrid automatic repeat request acknowledgment (HARQ-ACK) based on a set of transmission parameters.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE). The UE receives, on a down-link, an indication indicating a first number of predetermined time units for delaying sending an acknowledgment message after receiving data in a slot. The UE obtains one or more conditions based on the first number, the one or more conditions affecting time required for processing the data received in the slot and affecting a duration of a predetermined time unit. The UE determines whether at least one of the one or more conditions is met. The UE further sends, on an uplink, the acknowledgment message according to the first number predetermined time units after receiving the data in the slot when at least one of the one or more conditions is met.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating a base station in communication with a UE in an access network.

FIG. 4 illustrates an example logical architecture of a distributed access network.

FIG. 5 illustrates an example physical architecture of a distributed access network.

FIG. 6 is a diagram showing an example of a DL-centric subframe.

FIG. 7 is a diagram showing an example of an UL-centric subframe.

FIG. 8 is a diagram illustrating communications between a base station and UE.

FIG. 9 is a flow chart of a method (process) determining a delay for sending an acknowledgment message.

FIG. 10 is a conceptual data flow diagram illustrating the data flow between different components/means in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

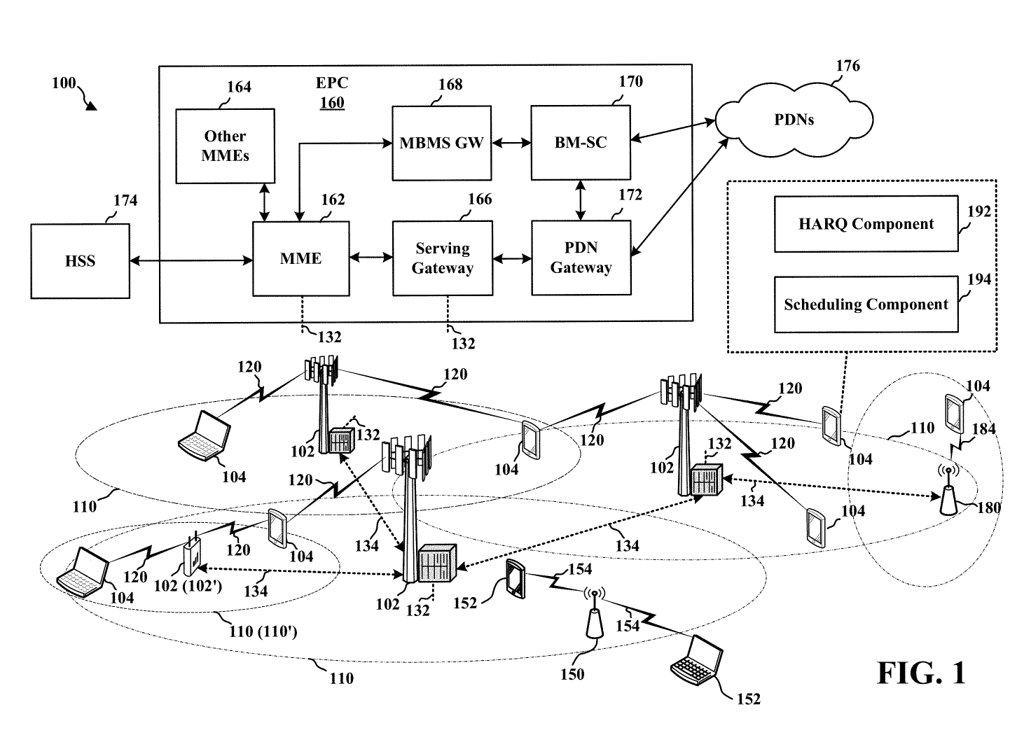

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 1 10. For example, the small cell 102′ may have a coverage area 110′ that overlaps the coverage area 1 10 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service (PSS), and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In certain aspects, the UE 104 includes, among other things, a hybrid automatic repeat request (HARQ) component 192 and a scheduling component 194. The UE 104 receives, on a down-link, an indication indicating a first number of predetermined time units for delaying sending an acknowledgment message after receiving data in a slot. The HARQ component 192 obtains one or more conditions based on the first number, the one or more conditions affecting time required for processing the data received in the slot and affecting a duration of a predetermined time unit. The HARQ component 192 determines whether at least one of the one or more conditions is met. The HARQ component 192 further instruct the scheduling component 194 to send, on an uplink, the acknowledgment message according to the first number predetermined time units after receiving the data in the slot when at least one of the one or more conditions is met.

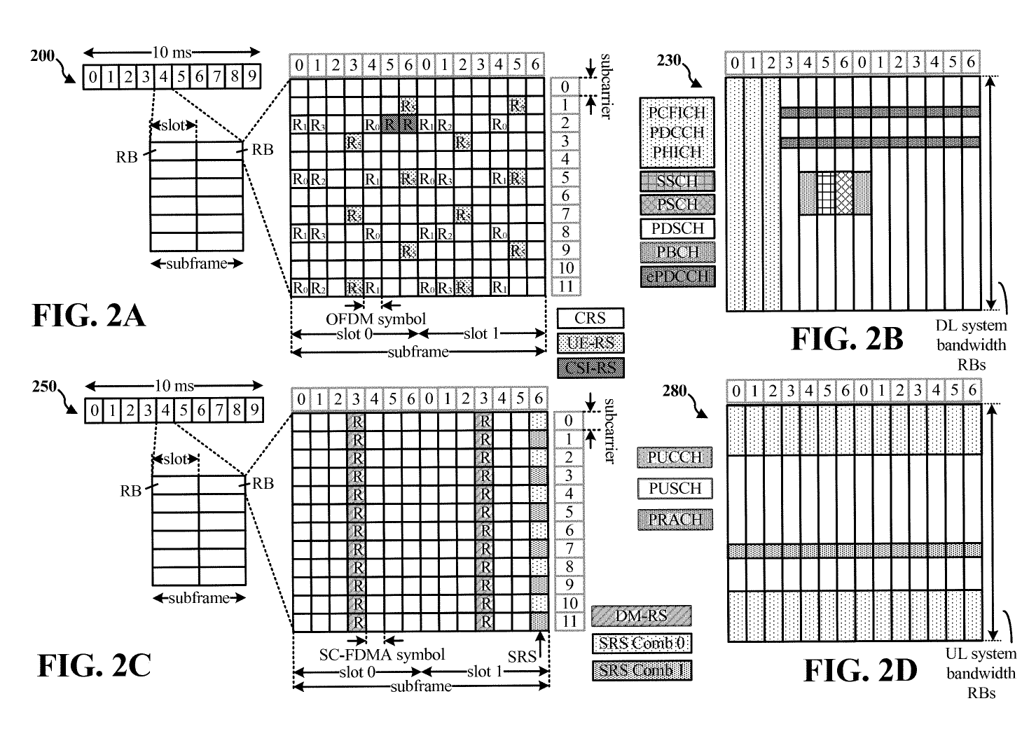

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB contains 12 consecutive subcarriers in the frequency domain and 7 consecutive symbols (for DL, OFDM symbols; for UL, SC-FDMA symbols) in the time domain, for a total of 84 REs. For an extended cyclic prefix, an RB contains 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R0, R1, R2, and R3, respectively), UE-RS for antenna port 5 (indicated as R5), and CSI-RS for antenna port 15 (indicated as R). FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL. FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

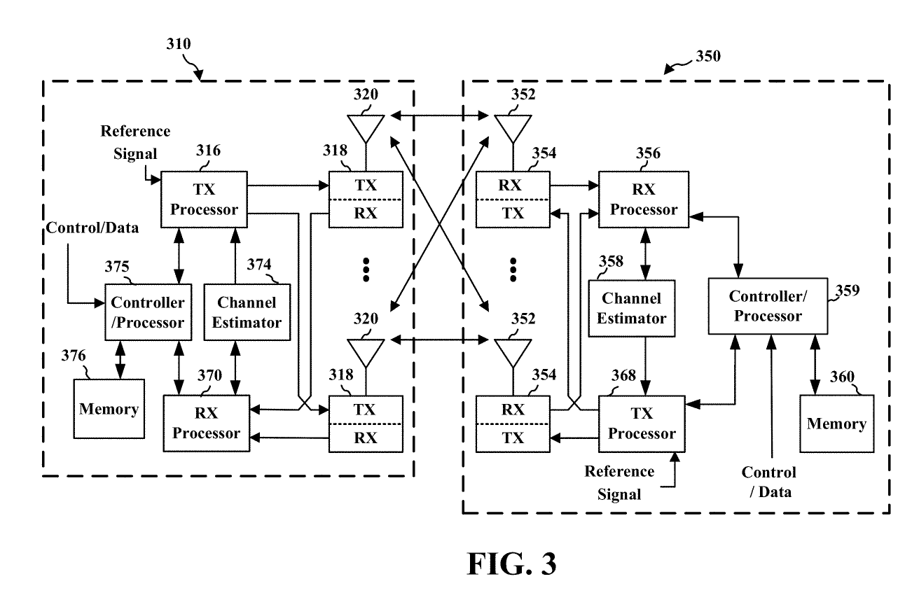

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission. The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

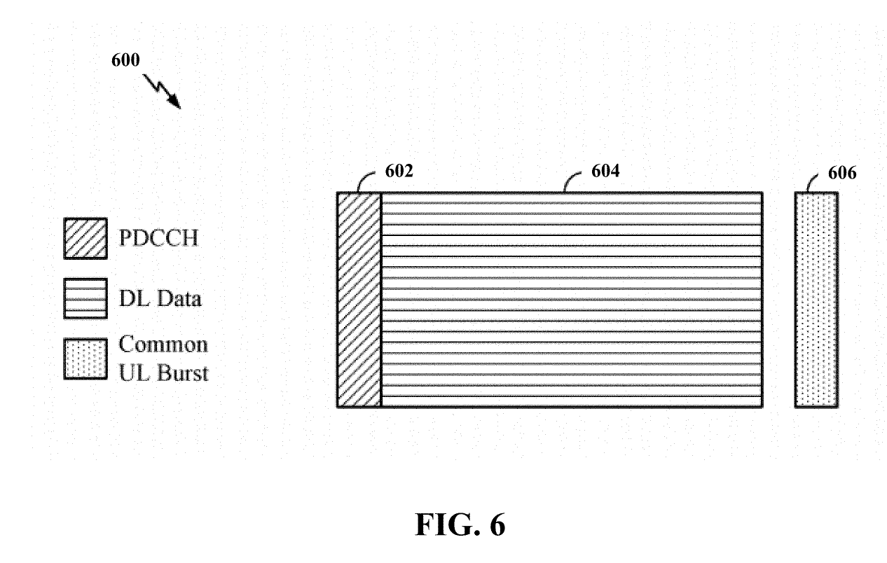

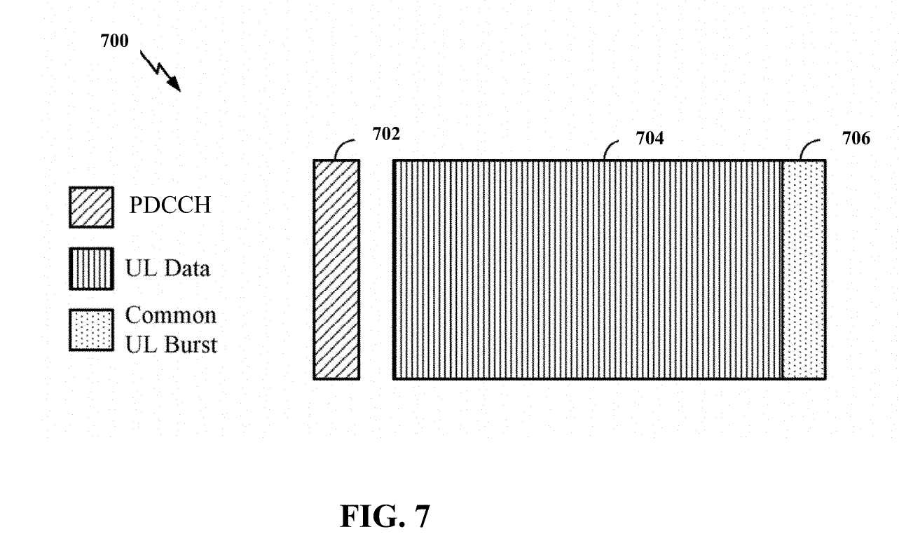

A single component carrier bandwidth of 100 MHZ may be supported. In one example, NR resource blocks (RBs) may span 12 sub-carriers with a sub-carrier bandwidth of 75 kHz over a 0.1 ms duration or a bandwidth of 15 kHz over a 1 ms duration. Each radio frame may consist of 10 or 50 subframes with a length of 10 ms. Each subframe may have a length of 0.2 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 6 and 7.

Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells. Alternatively, NR may support a different air interface, other than an OFDM-based interface.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

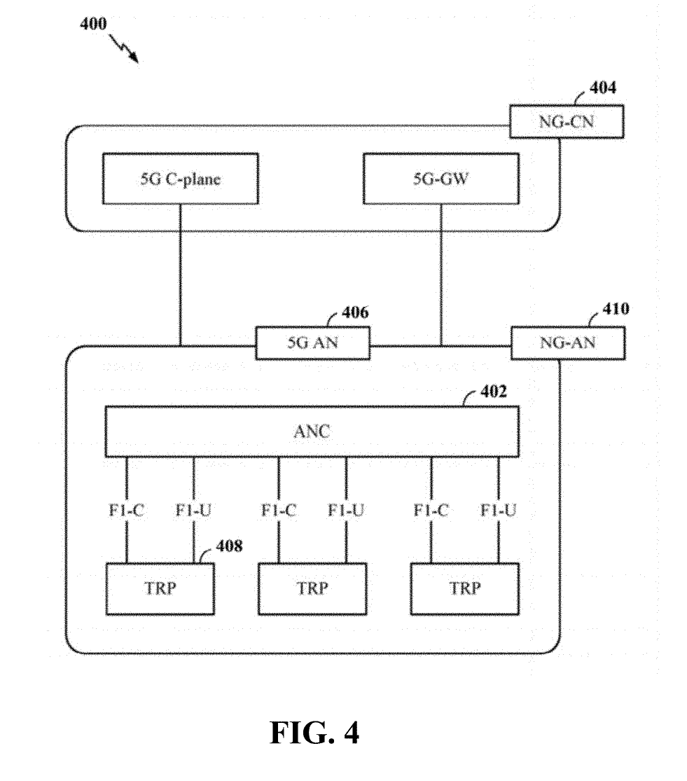

FIG. 4 illustrates an example logical architecture 400 of a distributed RAN, according to aspects of the present disclosure. A 5G access node 406 may include an access node controller (ANC) 402. The ANC may be a central unit (CU) of the distributed RAN 400. The backhaul interface to the next generation core network (NG-CN) 404 may terminate at the ANC. The backhaul interface to neighboring next generation access nodes (NG-ANs) may terminate at the ANC. The ANC may include one or more TRPs 408 (which may also be referred to as BSs, NR BSs, Node Bs, 5G NBs, APs, or some other term). As described above, a TRP may be used interchangeably with “cell.”

The TRPs 408 may be a distributed unit (DU). The TRPs may be connected to one ANC (ANC 402) or more than one ANC (not illustrated). For example, for RAN sharing, radio as a service (RaaS), and service specific AND deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 400 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 410 may support dual connectivity with NR. The NG-AN may share a common fronthaul for LTE and NR.

The architecture may enable cooperation between and among TRPs 408. For example, cooperation may be preset within a TRP and/or across TRPs via the ANC 402. According to aspects, no inter-TRP interface may be needed/present.

According to aspects, a dynamic configuration of split logical functions may be present within the architecture of the distributed RAN 400. The PDCP, RLC, MAC protocol may be adaptably placed at the ANC or TRP.

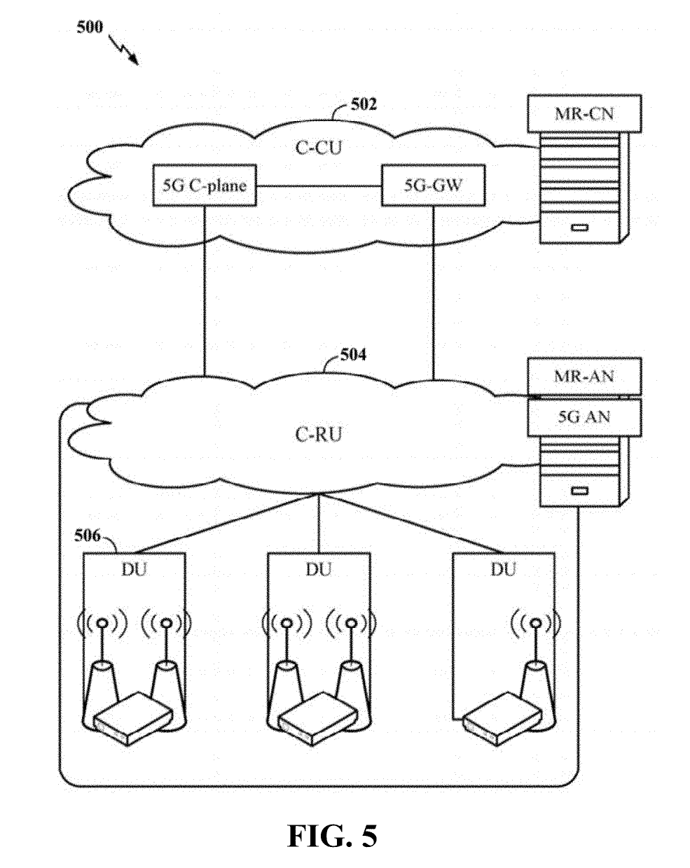

FIG. 5 illustrates an example physical architecture of a distributed RAN 500, according to aspects of the present disclosure. A centralized core network unit (C-CU) 502 may host core network functions. The C-CU may be centrally deployed. C-CU functionality may be offloaded (e.g., to advanced wireless services (AWS)), in an effort to handle peak capacity. A centralized RAN unit (C-RU) 504 may host one or more ANC functions. Optionally, the C-RU may host core network functions locally. The C-RU may have distributed deployment. The C-RU may be closer to the network edge. A distributed unit (DU) 506 may host one or more TRPs. The DU may be located at edges of the network with radio frequency (RF) functionality.

FIG. 6 is a diagram 600 showing an example of a DL-centric subframe. The DL-centric subframe may include a control portion 602. The control portion 602 may exist in the initial or beginning portion of the DL-centric subframe. The control portion 602 may include various scheduling information and/or control information corresponding to various portions of the DL-centric subframe. In some configurations, the control portion 602 may be a physical DL control channel (PDCCH), as indicated in FIG. 6. The DL-centric subframe may also include a DL data portion 604. The DL data portion 604 may sometimes be referred to as the payload of the DL-centric subframe. The DL data portion 604 may include the communication resources utilized to communicate DL data from the scheduling entity (e.g., UE or BS) to the subordinate entity (e.g., UE). In some configurations, the DL data portion 604 may be a physical DL shared channel (PDSCH).

The DL-centric subframe may also include a common UL portion 606. The common UL portion 606 may sometimes be referred to as an UL burst, a common UL burst, and/or various other suitable terms. The common UL portion 606 may include feedback information corresponding to various other portions of the DL-centric subframe. For example, the common UL portion 606 may include feedback information corresponding to the control portion 602. Non-limiting examples of feedback information may include an ACK signal, a NACK signal, a HARQ indicator, and/or various other suitable types of information. The common UL portion 606 may include additional or alternative information, such as information pertaining to random access channel (RACH) procedures, scheduling requests (SRs), and various other suitable types of information.

As illustrated in FIG. 6, the end of the DL data portion 604 may be separated in time from the beginning of the common UL portion 606. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 7 is a diagram 700 showing an example of an UL-centric subframe. The UL-centric subframe may include a control portion 702. The control portion 702 may exist in the initial or beginning portion of the UL-centric subframe. The control portion 702 in FIG. 7 may be similar to the control portion 602 described above with reference to FIG. 6. The UL-centric subframe may also include an UL data portion 704. The UL data portion 704 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 702 may be a physical DL control channel (PDCCH).

As illustrated in FIG. 7, the end of the control portion 702 may be separated in time from the beginning of the UL data portion 704. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 706. The common UL portion 706 in FIG. 7 may be similar to the common UL portion 706 described above with reference to FIG. 7. The common UL portion 706 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

Hybrid automatic repeat request (HARQ) is a combination of forward error correction (FEC) and ARQ. It uses error detection to detect uncorrectable errors. The packets in error are discarded, and the receiver requests retransmission of corrupted packets.

The HARQ mechanism includes multiple HARQ processes each operating on a single transport block (TB). The transmitter stops and waits for an acknowledgement from the receiver, called HARQ-ACK, after each transmission of TB. The HARQ-ACK indicates whether the TB has been correctly received or not.

From a latency perspective, the time between the reception of data and transmission of the HARQ-ACK should be as short as possible. An unnecessarily short time, however, would increase the demand on the processing capacity. Therefore, a trade-off between latency and implementation complexity is required.

The present disclosure provides a technique for transmitting HARQ-ACK by a user equipment (UE). A UE receives the signaling from the network about the HARQ-ACK timing, i.e., the time duration between the data reception and the transmission of the associated HARQ-ACK. The UE evaluates its processing capability to judge whether it can send out the HARQ-ACK in time. The behavior of HARQ-ACK transmission is determined based on the evaluation of whether the HARQ-ACK can be sent out in time.

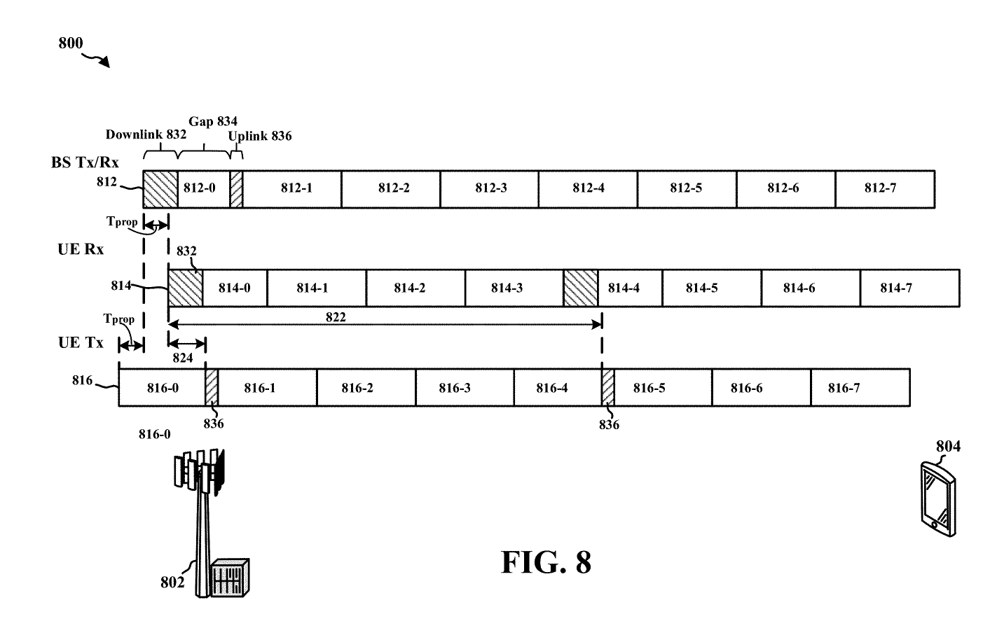

FIG. 8 is a diagram 800 illustrating communication between a base station 802 and a UE 804. The base station 802 communicates with the base station 802 according to a time structure defined by slots 812-0 to 812-7. The UE 804 receives down-link signals from the base station 802 according to a time structure defined by slots 814-0 to 814-7. The UE 804 transmits up-link signals to the base station 802 according to a time structure defined by slots 816-0 to 816-7. Further, each time slot has a down-link portion 832, a gap portion 834, and an up-link portion 836. The base station 802 may transmit PDDCH, PDSCH and other down-link channels in the down-link portion 832. There is no transmission in the gap portion 834. The UE 804 may transmit PUCCH, PUSCH and other up-link channels in the up-link portion 836.

The UE 804 receives a set of configuration information from the base station 802. Based on the configuration information, the UE 804 can derive the timing relation between the reception of data in the downlink and transmission of the HARQ-ACK in the uplink. In certain configurations, this timing relation can be defined by an integer K1 that is equal to or greater than 0. K1 indicates that the HARQ-ACK is to be transmitted in the (n+K1)^{th} slot if the corresponding downlink data are received in the n-th slot. For example, the UE 804 may receive from higher layers (through the base station 802) a semi-static configuration indicating the value of K1.

As described supra, the determination of the HARQ timing should consider the trade-off between latency and implementation complexity. If the timing is short, a UE may not be able to send the HARQ-ACK in time because the timing requirement exceeds the processing capability of the UE.

In this example, the HARQ round-trip time (RTT) is 8 slots. When the base station 802 transmits down-link data in the slot 812-0, due to the distance between the base station 802 and the UE 804, the UE 804 receives the data in the slot 814-0, which is a propagation delay Tₚᵣₒₚ after the slot 812-0. The Tₚᵣₒₚ is the time duration required for a signal to travel from the base station 802 to the UE 804. The UE 804 decodes the signal received in the slot 814-0, and then generates an HARQ-ACK for the received signal. Subsequently, the UE 804 transmits the HARQ-ACK to the base station 802. In certain configurations, the HARQ-ACK is transmitted in the latter part of slot 814-4. In particular, the HARQ-ACK may be transmitted in the up-link portion 836 at the end of the slot 816-4.

In one example, the UE 804 transmits a signal to the base station 802 in the slot 816-0. In order for the base station 802 to receive the signal in the slot 812-0, due to the distance between the UE 804 and the base station 802, the UE 804 sets the slot 816-0 one Tₚᵣₒₚ prior to the slot 812-0. Accordingly, the slot 816-0 is two Tₚᵣₒₚ prior to the slot 812-0.

Upon reception of the HARQ-ACK, the base station 802 can, if needed, retransmit the downlink data in slot 812-8. Thus, in this example, the HARQ RTT is equal to the duration of 8 slots. A delay 822, which is from the start of the down-link portion 832 in the slot 814-0 to the start of the up-link portion 836 in the slot 816-4, is equal to the result of subtracting two Tₚᵣₒₚ and the up-link portion 836 from a duration of 5 time slots. This relationship in this example can be represented by Equation (1):

Delay=5×Tₛ−2 ×Tₚᵣₒₚ−Tᵤₚ, (1)

where Tₛ is the duration of a single time slot, and Tᵤₚ is the duration of the up-link portion 836.

When the HARQ RTT is equal to the duration of m slots, m being an integer greater than 1, and the HARQ-NACK and the associated downlink data are not in the same slot (i.e., K1≠0), the delay can be represented by Equation (2):

Delay=(1+m/2)×Tₓ−2*Tₚᵣₒₚ−Tᵤₚ, (2)

When the HARQ-NACK and the associated downlink data are in the same slot (i.e., K1=0, so-called “self-contained”), a delay 824 can be represented by Equation (3):

Delay=Tₛ−2*Tₚᵣₒₚ−Tᵤₚ, (3)

Upon receiving the down-link signal in the down-link portion 832 of the slot 814-0, the UE 804 processes the down-link signal and prepares to transmit a corresponding HARQ-ACK. More specifically, the UE 804 demodulates and decodes the downlink control channel carried in the down-link portion 832. The UE 804 also demodulates and decodes the downlink data channel carried in the down-link portion 832. The UE 804 generate a HARQ-ACK and encodes the HARQ-ACK. The UE 804 then switches from downlink reception mode to uplink transmission node in order to transmit the HARQ-ACK to the base station 802.

The processing time at the UE 804 is proportional to the number of component carriers established between the UE 804 and the base station 802. The processing time is also proportional to the duration of the downlink control channel. Thus, the delay requirement, as indicated in the number of slots or symbol periods, for the UE 804 is stricter when the duration of the downlink control channel is longer. The delay requirement for the UE 804 is less strict when the subcarrier spacing is smaller. This is because a smaller subcarrier spacing leads to a longer OFDM symbol duration. The delay requirement for the UE 804 is less strict when the number of OFDM symbols in a slot is larger. The delay requirement for the UE 804 is less strict when the number of OFDM symbols of the HARQ-ACK is smaller. The delay requirement for the UE 804 is less strict when the timing advance, which is twice of the Tₚᵣₒₚ, has a shorter duration. The delay requirement for the UE 804 is stricter when time-domain interleaving is applied in the downlink data channel. This is because UE pipeline processing is less applicable when time domain interleaving is applied in the downlink data channel. The delay requirement for the UE 804 is stricter when the resource element mapping of the downlink data channel is time first. This is because UE pipeline processing in time is less applicable when time domain interleaving is applied in the downlink data channel.

The UE 804 can be configured with multiple transmission parameters (e.g., P1 to P8) according the factors described supra. P1 indicates the number of configured component carriers. P2 indicates the number of OFDM symbols in the region where the UE 804 monitors the downlink control channel. P3 indicates the subcarrier spacing. P4 indicates the number of OFDM symbols in a slot. P5 indicates the number of OFDM symbols in HARQ-ACK. P6 indicates the duration of timing advance. P7 indicates whether or not the time-domain interleaving is applied in the downlink data channel. P8 indicates whether or not the resource element mapping of the downlink data channel is time first. The transmission parameters may also include other parameters.

The UE 804 may receive from the base station 802 an indication indicating the delay for sending a HARQ-ACK. In particular, the indication may indicate a number K1, which instructs the UE 804 that the delay is K1 slots (or symbol periods). The value of K1 can be signaled from the base station 802 to the UE 804 by physical-layer signaling. The value of K1 can also be signaled from the base station 802 to the UE 804 by MAC-layer signaling. The value of K1 can further be signaled from the base station 802 to the UE 804 by RRC-layer signaling.

In certain configurations, the UE 804 may select a set of transmission parameters from the transmission parameters described supra for each supported subcarrier spacing. For example, the UE 804 may select four parameters P1, P3, P4, and P5 for the subcarrier spacing 15 KHz.

Further, for a given subcarrier spacing, the UE 804 determines a condition for the set of transmission parameters defined for the value of the received K1. When the set of transmission parameters meets the condition defined, the UE 804 can determine that a HARQ-ACK corresponding to a downlink data reception can be sent out in time. For example, when K1 is 0, the condition is that P3 is 30 KHz, P1 is 1, P4 is 14, and P5 is less than or equal to 2. When K1 is 2, the condition is that P3 is 30 KHz, P1 is 1, P4 is 14, and P5 is less than or equal to 2; or that P3 is 60 KHz, P1 is 1, P4 is 14, and P5 is less than or equal to 2. When K1 is 4, the condition is that P3 is 30 KHz and P1 is greater than 1; that P3 is 30 KHz and P4 is 7; that P3 is 30 KHz and P5 is greater than 2; that P3 is 60 KHz and P1 is greater than 1; that P3 is 60 KHz and P4=7; or that P3 is 60 KHz and P5 is greater than 2.

When the UE 804 determines that, for a K1 value received from the base station 802, at least one of the corresponding conduction(s) is met, the UE 804 further determines that it can transmit a corresponding HARQ-ACK after the delay as indicated by K1. In other words, the UE 804 determines that the delay as indicated by K1 provides sufficient time to the UE 804 for processing the down-link signal and preparing a corresponding HARQ-ACK when at least one of the corresponding conditions is met. Otherwise, the UE 804 may choose not to transmit a HARQ-ACK on up-link. Alternatively, the UE 804 may transmit a HARQ-ACK on up-link based on a default value of K1 (e.g., the largest value of K1).

In another example, K1 is used to indicate a delay in slots between the slot for PDSCH reception (e.g., the slot 814-0) and the slot for corresponding acknowledgement transmission on uplink (e.g., the slot 816-4). The UE 804 receives the value of K1 semi-statically from the base station 802. The UE 804 determines that for a 15 KHz subcarrier spacing, K1 may be at least in the range from 1 to 4 (inclusive). The UE 804 can support K1 having values 1 or 2 with the following condition: the UE 804 operates on a single carrier; the slot length is 14 OFDM symbol periods; the PDCCH occupies up to 2 OFDM symbol periods; the HARQ-ACK uses PUCCH/PUSCH with a time length of 1 or 2 OFDM symbol periods; the timing advance (TA) value (including TA offset for TDD) is no larger than a round-trip time for 5 kilometers (about 2*5e3/3e8 seconds); and no time-domain interleaving is applied in PDSCH. Otherwise, the UE 804 is configured to apply K1 with a value 3 or 4. The UE 804 may not feedback HARQ-ACK on uplink based on the received K1 value if the K1 value is less than 3.

The UE 804 determines that for a 30 KHz subcarrier spacing, K1 may be at least in the range from 1 to 4 (inclusive). The UE 804 can support K1 having values 1 or 2 with the following condition: the UE 804 operates on a single carrier; the slot length is 14 OFDM symbol periods; the PDCCH occupies up to 2 OFDM symbol periods; no time-domain interleaving is applied in PDSCH; an actual data rate is no larger than 50% of a peak data rate that the UE 804 can support; the HARQ-ACK uses PUCCH/PUSCH with a time length of 1 or 2 OFDM symbol periods; the TA value (including TA offset for TDD) is no larger than a round-trip time for 5 kilometers (about 2*5e3/3e8 seconds); Otherwise, UE 804 is configured to apply K1 with a value of 3 or 4. The UE 804 may not feedback HARQ-ACK on uplink based on the received K1 value if the K1 value is less than 3.

The UE 804 determines that for a 60 KHz subcarrier spacing, K1 may be at least in the range from 4 to 8 (inclusive). The UE 804 can support K1 having values 4 to 7 with the following condition: the UE 804 operates on a single carrier; the slot length is 14 OFDM symbol periods; the PDCCH occupies up to 2 OFDM symbol periods; no time-domain interleaving is applied in PDSCH; the TA value (including TA offset for TDD) is no larger than a round-trip time for 5 kilometers (about 2*5e3/3e8 seconds); Otherwise, UE 804 is configured to apply K1 with a value of 8. The UE 804 may not feedback HARQ-ACK on uplink based on the received K1 value if the K1 value is less than 8

The UE 804 determines that for a 120 KHz subcarrier spacing, K1 may be at least in the range from 4 to 8 (inclusive). The UE 804 can support K1 having values 4 to 7 with the following condition: the UE 804 operates on a single carrier; the PDCCH occupies up to 2 OFDM symbol periods; no time-domain interleaving is applied in PDSCH; the TA value (including TA offset for TDD) is no larger than a round-trip time for 1732 meters (about 2*1732/3e8 seconds). Otherwise, UE 804 is configured to apply K1 with a value of 8. The UE 804 may not feedback HARQ-ACK on uplink based on the received K1 value if the K1 value is less than 8.

If the UE 804 supports up to 30 KHz subcarrier spacings, the UE 804 may optionally use K1 with a value of 0. The UE 804 can support K1 having a value 0 with the following condition: the UE 804 operates on a single carrier; the slot length is 14 OFDM symbol periods; the PDCCH occupies up to 2 OFDM symbol periods; no time-domain interleaving is applied in PDSCH; an actual data rate is no larger than 25% of a peak data rate that the UE 804 can support; the HARQ-ACK uses PUCCH/PUSCH with a time length of 1 OFDM symbol period; the TA value (including TA offset for TDD) is no larger than a round-trip time for 1732 meters (about 2*1732/3e8 seconds); the time difference between PDSCH ending symbol and PUCCH/PUSCH starting symbol is no smaller than 1 OFDM symbol. Otherwise, the UE 804 may determine to use a K1 value other than 0. The UE 804 may not feedback HARQ-ACK on uplink based on the received K1 value if the K1 value is 0.

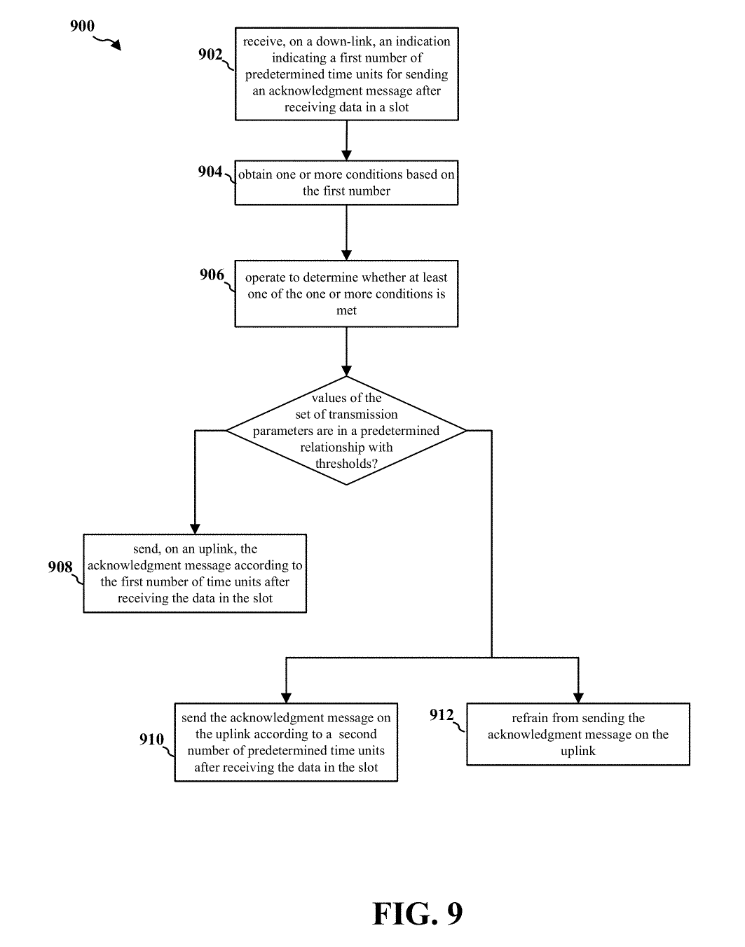

FIG. 9 is a flow chart 900 of a method (process) for determining a delay for sending an acknowledgment message. The method may be performed by a UE (e.g., the UE 804, the apparatus 1002, and the apparatus 1002′). At operation 902, the UE receives, on a down-link, an indication indicating a first number (e.g., K1) of predetermined time units (e.g., the slots 816-0 to 816-7) for sending an acknowledgment message (e.g., the HARQ-ACK) after receiving data in a slot (e.g., the slot 814-0).

At operation 904, the UE obtains one or more conditions based on the first number. The one or more conditions affect time required for processing the data received in the slot and affecting a duration of a predetermined time unit.

At operation 906, the UE operates to determine whether at least one of the one or more conditions is met. In certain configurations, each of the one or more conditions includes thresholds of a set of transmission parameters (e.g., P1 to P8, etc.). At operation 907, the UE determines whether values of the set of transmission parameters of the at least one condition are in a predetermined relationship with the thresholds.

When the values are in the predetermined relationship with the thresholds (e.g., P1 is 1, P4 is 14, and P5 is less than or equal to 2), at operation 908, the UE sends, on an uplink, the acknowledgment message according to the first number predetermined time units (e.g., at the K1-th time slot) after receiving the data in the slot.

When the values are not in the predetermined relationship with the thresholds of each of the one or more conditions, the UE may choose to send, at operation 910, the acknowledgment message on the uplink according to a second number of predetermined time units after receiving the data in the slot, the second number having a pre-configured default value. Alternatively, the UE may, at operation 912, choose to refrain from sending the acknowledgment message on the uplink.

In certain configurations, the indication is carried by a physical layer signaling, a medium access control (MAC) layer signaling, or a radio resource control (RRC) layer signaling. In certain configurations, each of the predetermined time units is a time slot.

In certain configurations, the set of transmission parameters includes one or more of: a number of component carriers established at the UE; a number of Orthogonal Frequency Division Multiplexing (OFDM) symbols in a control region of the slot; a subcarrier spacing of the number of component carriers; a number of OFDM symbol periods in the slot; a number of OFDM symbol periods occupied by the acknowledgment message; a duration of a timing advance at the UE; a parameter indicating whether or not time-domain interleaving is applied in a downlink control channel transmitted in the slot; and a parameter indicating whether or not a resource element mapping of a downlink data channel transmitted in the slot is time first.

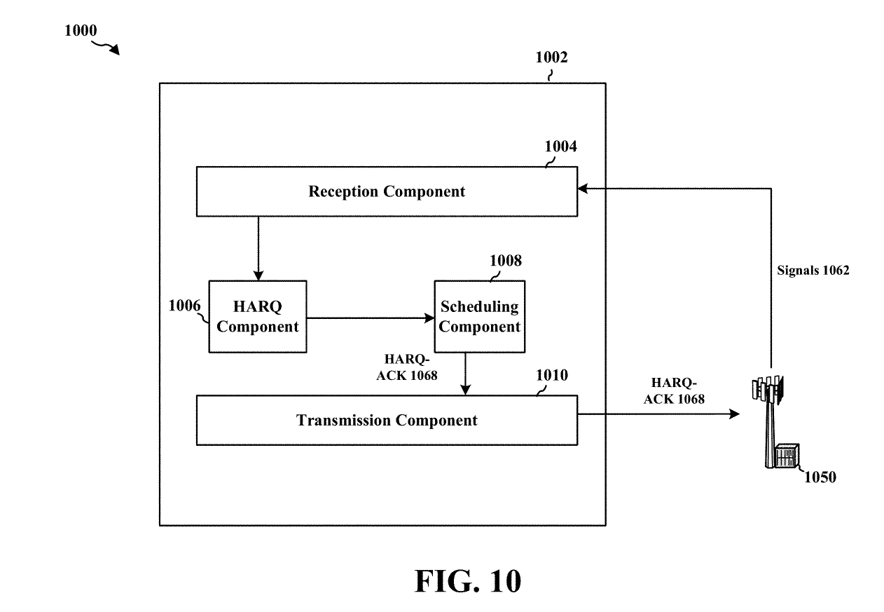

FIG. 10 is a conceptual data flow diagram 1000 illustrating the data flow between different components/means in an exemplary apparatus 1002. The apparatus 1002 may be a first UE. The apparatus 1002 includes a reception component 1004, a HARQ component 1006, a scheduling component 1008, and a transmission component 1010. The reception component 1004 may receive signals 1062 from a base station 1050.

In one aspect, the reception component 1004 receives, on a down-link, an indication indicating a first number (e.g., K1) of predetermined time units (e.g., the slots 816-0 to 816-7) for sending an acknowledgment message (e.g., the HARQ-ACK) after receiving data in a slot (e.g., the slot 814-0).

The HARQ component 1006 obtains one or more conditions based on the first number. The one or more conditions affect time required for processing the data received in the slot and affecting a duration of a predetermined time unit.

The HARQ component 1006 operates to determine whether at least one of the one or more conditions is met. In certain configurations, each of the one or more conditions includes thresholds of a set of transmission parameters (e.g., P1 to P8, etc.). The HARQ component 1006 determines whether values of the set of transmission parameters of the at least one condition are in a predetermined relationship with the thresholds.

When the values are in the predetermined relationship with the thresholds (e.g., P1 is 1, P4 is 14, and P5 is less than or equal to 2), at operation 908, the HARQ component 1006 instruct the scheduling component 1008 to send, on an uplink, the acknowledgment message according to the first number predetermined time units (e.g., at the K1-th time slot) after receiving the data in the slot.

When the values are not in the predetermined relationship with the thresholds of each of the one or more conditions, the HARQ component 1006 may choose to instruct the scheduling component 1008 to send the acknowledgment message on the uplink according to a second number of predetermined time units after receiving the data in the slot, the second number having a pre-configured default value. Alternatively, the HARQ component 1006 may choose to refrain from sending the acknowledgment message on the uplink.

In certain configurations, the indication is carried by a physical layer signaling, a medium access control (MAC) layer signaling, or a radio resource control (RRC) layer signaling. In certain configurations, each of the predetermined time units is a time slot.

In certain configurations, the set of transmission parameters includes one or more of: a number of component carriers established at the UE; a number of Orthogonal Frequency Division Multiplexing (OFDM) symbols in a control region of the slot; a subcarrier spacing of the number of component carriers; a number of OFDM symbol periods in the slot; a number of OFDM symbol periods occupied by the acknowledgment message; a duration of a timing advance at the UE; a parameter indicating whether or not time-domain interleaving is applied in a downlink control channel transmitted in the slot; and a parameter indicating whether or not a resource element mapping of a downlink data channel transmitted in the slot is time first.

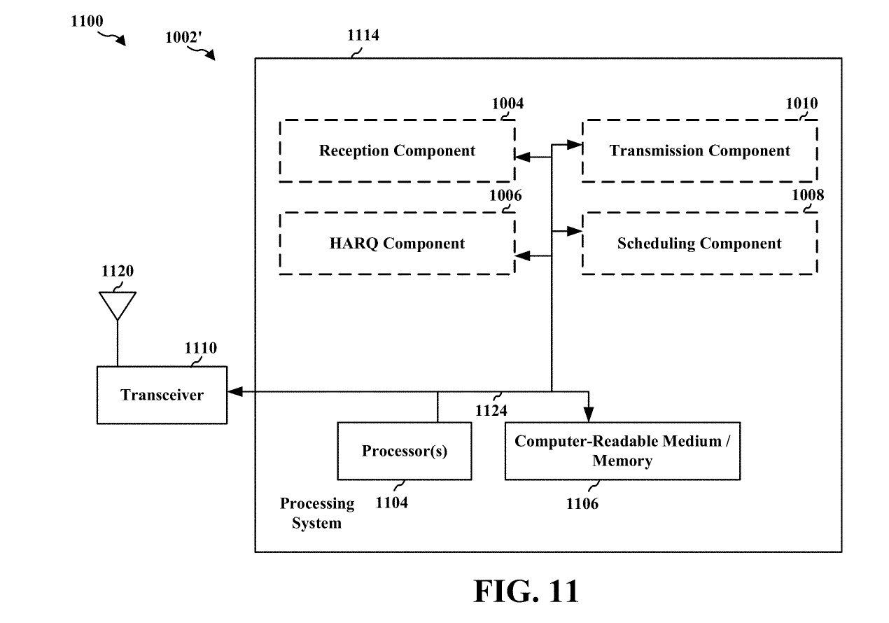

FIG. 11 is a diagram 1100 illustrating an example of a hardware implementation for an apparatus 1002′ employing a processing system 1114. The apparatus 1002′ may be a UE. The processing system 1114 may be implemented with a bus architecture, represented generally by a bus 1124. The bus 1124 may include any number of interconnecting buses and bridges depending on the specific application of the processing system 1114 and the overall design constraints. The bus 1124 links together various circuits including one or more processors and/or hardware components, represented by one or more processors 1104, the ***reception component 1004, the HARQ component 1006, the scheduling component 1008, the transmission component 1010, and a computer-readable medium/memory 1106. The bus 1124 may also link various other circuits such as timing sources, peripherals, voltage regulators, and power management circuits, etc.

The processing system 1114 may be coupled to a transceiver 1110, which may be one or more of the transceivers 354. The transceiver 1110 is coupled to one or more antennas 1120, which may be the communication antennas 352.

The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the transmission component 1010, and based on the received information, generates a signal to be applied to the one or more antennas 1120.

The processing system 1114 includes one or more processors 1104 coupled to a computer-readable medium/memory 1106. The one or more processors 1104 are responsible for general processing, including the execution of software stored on the computer-readable medium/memory 1106. The software, when executed by the one or more processors 1104, causes the processing system 1114 to perform the various functions described supra for any particular apparatus. The computer-readable medium/memory 1106 may also be used for storing data that is manipulated by the one or more processors 1104 when executing software. The processing system 1114 further includes at least one of the ***reception component 1004, the HARQ component 1006, the scheduling component 1008, and the transmission component 1010. The components may be software components running in the one or more processors 1104, resident/stored in the computer readable medium/memory 1106, one or more hardware components coupled to the one or more processors 1104, or some combination thereof. The processing system 1114 may be a component of the UE 350 and may include the memory 360 and/or at least one of the TX processor 368, the RX processor 356, and the communication processor 359.

In one configuration, the apparatus 1002/apparatus 1002′ for wireless communication includes means for performing each of the operations of FIG. 9. The aforementioned means may be one or more of the aforementioned components of the apparatus 1002 and/or the processing system 1114 of the apparatus 1002′ configured to perform the functions recited by the aforementioned means.

As described supra, the processing system 1114 may include the TX Processor 368, the RX Processor 356, and the communication processor 359. As such, in one configuration, the aforementioned means may be the TX Processor 368, the RX Processor 356, and the communication processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
receiving, on a down-link, an indication indicating a first number of predetermined time units for delaying sending an acknowledgment message after receiving data in a slot;
obtaining one or more conditions based on the first number, the one or more conditions affecting time required for processing the data received in the slot and affecting a duration of a predetermined time unit;
determining whether at least one of the one or more conditions is met; and
sending, on an uplink, the acknowledgment message according to the first number predetermined time units after receiving the data in the slot when at least one of the one or more conditions is met.

2. The method of claim 1, wherein each of the predetermined time units is a time slot.

3. The method of claim 1,
wherein each of the one or more conditions includes thresholds of a set of transmission parameters, wherein the determining whether at least one of the one or more conditions is met includes:
determining whether values of the set of transmission parameters of the at least one condition are in a predetermined relationship with the thresholds.

4. The method of claim 3, wherein the set of transmission parameters includes one or more of:
a number of component carriers established at the UE;
a number of Orthogonal Frequency Division Multiplexing (OFDM) symbols in a control region of the slot;
a subcarrier spacing of the number of component carriers;
a number of OFDM symbol periods in the slot;
a number of OFDM symbol periods occupied by the acknowledgment message;
a duration of a timing advance at the UE;
a parameter indicating whether or not time-domain interleaving is applied in a downlink control channel transmitted in the slot; and
a parameter indicating whether or not a resource element mapping of a downlink data channel transmitted in the slot is time first.

5. The method of claim 1, further comprising:
sending the acknowledgment message on the uplink according to a second number of predetermined time units after receiving the data in the slot, when each of the one or more conditions is not met, the second number having a pre-configured default value.

6. The method of claim 1, further comprising:
refraining from sending the acknowledgment message on the uplink, when each of the one or more conditions is not met.

7. The method of claim 1, wherein the indication is carried by a physical layer signaling, a medium access control (MAC) layer signaling, or a radio resource control (RRC) layer signaling.

8. An apparatus for wireless communication, the apparatus being a user equipment (UE), comprising:
a memory; and
at least one processor coupled to the memory and configured to:
receive, on a down-link, an indication indicating a first number of predetermined time units for delaying sending an acknowledgment message after receiving data in a slot;
obtain one or more conditions based on the first number, the one or more conditions affecting time required for processing the data received in the slot and affecting a duration of a predetermined time unit;
determine whether at least one of the one or more conditions is met; and
send, on an uplink, the acknowledgment message according to the first number predetermined time units after receiving the data in the slot when at least one of the one or more conditions is met.

9. The apparatus of claim 8, wherein each of the predetermined time units is a time slot.

10. The apparatus of claim 8, wherein each of the one or more conditions includes thresholds of a set of transmission parameters, wherein to determine whether at least one of the one or more conditions is met, the at least one processor is further configured to:
determine whether values of the set of transmission parameters of the at least one condition are in a predetermined relationship with the thresholds.

11. The apparatus of claim 10, wherein the set of transmission parameters includes one or more of:
a number of component carriers established at the UE;
a number of Orthogonal Frequency Division Multiplexing (OFDM) symbols in a control region of the slot;
a subcarrier spacing of the number of component carriers;
a number of OFDM symbol periods in the slot;
a number of OFDM symbol periods occupied by the acknowledgment message;
a duration of a timing advance at the UE;
a parameter indicating whether or not time-domain interleaving is applied in a downlink control channel transmitted in the slot; and
a parameter indicating whether or not a resource element mapping of a downlink data channel transmitted in the slot is time first.

12. The apparatus of claim 8, wherein the at least one processor is further configured to:
send the acknowledgment message on the uplink according to a second number of predetermined time units after receiving the data in the slot, when each of the one or more conditions is not met, the second number having a pre-configured default value.

13. The apparatus of claim 8, wherein the at least one processor is further configured to:
refrain from sending the acknowledgment message on the uplink, when each of the one or more conditions is not met.

14. The apparatus of claim 8, wherein the indication is carried by a physical layer signaling, a medium access control (MAC) layer signaling, or a radio resource control (RRC) layer signaling.

15. A computer-readable medium storing computer executable code for wireless communication of a user equipment (UE), comprising code to:
receive, on a down-link, an indication indicating a first number of predetermined time units for delaying sending an acknowledgment message after receiving data in a slot;
obtain one or more conditions based on the first number, the one or more conditions affecting time required for processing the data received in the slot and affecting a duration of a predetermined time unit;
determine whether at least one of the one or more conditions is met; and
send, on an uplink, the acknowledgment message according to the first number predetermined time units after receiving the data in the slot when at least one of the one or more conditions is met.

16. The computer-readable medium of claim 15, wherein each of the predetermined time units is a time slot.

17. The computer-readable medium of claim 15, wherein each of the one or more conditions includes thresholds of a set of transmission parameters, wherein to determine whether at least one of the one or more conditions is met, the code is further configured to:
determine whether values of the set of transmission parameters of the at least one condition are in a predetermined relationship with the thresholds.

18. The computer-readable medium of claim 17, wherein the set of transmission parameters includes one or more of:
a number of component carriers established at the UE;
a number of Orthogonal Frequency Division Multiplexing (OFDM) symbols in a control region of the slot;
a subcarrier spacing of the number of component carriers;
a number of OFDM symbol periods in the slot;
a number of OFDM symbol periods occupied by the acknowledgment message;
a duration of a timing advance at the UE;
a parameter indicating whether or not time-domain interleaving is applied in a downlink control channel transmitted in the slot; and
a parameter indicating whether or not a resource element mapping of a downlink data channel transmitted in the slot is time first.

19. The computer-readable medium of claim 15, wherein the code is further configured to:
send the acknowledgment message on the uplink according to a second number of predetermined time units after receiving the data in the slot, when each of the one or more conditions is not met, the second number having a pre-configured default value.

20. The computer-readable medium of claim 15, wherein the code is further configured to:
refrain from sending the acknowledgment message on the uplink, when each of the one or more conditions is not met.
